(19) United States
(12) Patent Application Publication
(10) Pub. No.: US 2003/0187583 A1
(43) Pub. Date: Oct. 2, 2003

(54) Method and apparatus for resolving shear wave seismic data

(76) Inventors: Federico D. Martin, Missouri City, TX (US); John A. Ward, Humble, TX (US)

Correspondence Address: Petroleum Geo-Services, Inc., Suite 600, 16010 Barker's Point Lane, Houston, TX, 77079, US

(21) Appl. No.: 10/113,106

(22) Filed: Apr. 1, 2002

(51) Int. Cl. G01V 1/28

(52) U.S. Cl. 702/14

(57) ABSTRACT

The present invention relates to an improved method and system for computing residual statics on shear wave seismic data. The invention uses pilot traces, which are a function of CDP, offset, and azimuth, to resolve shear wave data in the presence of any anisotropy. Statics determinations are made that are not velocity error dependent; the need for CMP to CCP transformations is eliminated. The present invention also relates to a method and apparatus for removing regional anisotropy effects. The present invention, in one embodiment, determines statics for shear wave seismic data by binning seismic data in a bin defined by CDP information, azimuth information and offset information, where a set of binned traces is defined; generating a pilot trace from the set of binned traces; cross-correlating the pilot trace with the binned traces; determining shot statics dependent on the cross-correlation; and determining receiver statics dependent on the cross-correlation.

### BACKGROUND OF THE INVENTION

The present invention relates to resolving seismic data. More particularly, the present invention relates to digital signal processing techniques related to surface-consistent residual statics and normal moveout corrections for three-dimensional pressure-shear and shear-shear seismic data.

Raw seismic data is typically obtained through the use of a seismic source (a.k.a., a “shot”) and a receiver (typically a hydrophone or geophone). This acquisition process occurs on land and in a marine setting, and this process is well known in the art. In a typical sea-based exploration, as shown in FIG. 1, a seismic source 15 is towed on a source cable 10 behind a sea going vessel 7 with receivers 30a through 30f lying on the sea bed 25. The receivers are typically connected to each other by receiver cable 35. The seismic waves 20, generated from the seismic source 15, travel through the water, into the seabed 25, and reflect off horizons (not shown) in the earth's surface. The incident, reflected, and refracted seismic energy is sensed by the receivers 30a-30f. Receiver cable 35 connects receivers 30a-30f to a recorder (not shown), which is typically on another vessel or a buoy.

Acoustic waves in water consist of pressure waves. However, as seen in FIG. 2a, when the pressure wave 42 encounters an interface of different acoustic impedance 40, the wave breaks into, generally, three different components. The first component 46 is a reflected pressure or P-wave. The second component 48 is a refracted P-wave. The third component 50 is a refracted, mode-converted shear wave (a.k.a. “S-wave”) of SV-wave polarization. At the boundary 40, mode conversion from P to S waves occurs, and the survey data is referred to as PS data. Converted shear waves are seismic vibrations; they are waves for which the vibrations occur essentially perpendicular to the direction of pressure wave propagation and are polarized in the shot to receiver azimuth plane. FIG. 2b shows the case where the pressure wave 42 starts in a solid, such as during a land survey, and the pressure wave 42 encounters an interface of different acoustic impedance 52. Here, the wave breaks generally into four different components, three of which (44, 46, and 48) can be described in a similar manner as above. The fourth component is a reflected, mode-converted S-wave 44. For the liquid-to-solid case illustrated by FIG. 2a no S-wave energy can be transmitted in the liquid; hence there is no reflected, mode-converted S-wave. Also, for land data, there are shear sources that generate what is referred to as “SS” data (pure S-waves that have not been mode-converted).

Most seismic surveys collect the data associated with pressure waves and process this data using techniques well known in the art. The pressure survey's end result is typically a model of the structures present in the earth. Comparing the pressure surveys to shear surveys enhances the information resulting from these techniques. The comparison shows, for example, areas of fluid that might not be detected with only a pressure survey.

One of the problems in making shear wave surveys is that of determining the so-called “residual statics” corrections. Residual statics, also referred to as simply “statics,” are corrections applied to seismic data to compensate for the effects of variations in elevation, weathering thickness, weathering velocity, or reference to a datum. The objective is to determine the reflection arrival times which would have been observed if all measurements had been observed and if all measurements had been made on a substantially flat plane with no weathering or low-velocity material present. Underlying the concept of static corrections is the assumption that a simple time shift of an entire seismic trace will yield the seismic record that would have been observed if the receivers had been displaced vertically downward to the reference datum.

Conventional methods for computing residual statics for “pressure-pressure” (PP) data require determining relative “pick times” of traces by cross-correlating these traces with a “pilot” trace. A pilot trace is the seismic trace toward which other traces are adjusted and is typically a signal-enhanced common midpoint (“CMP”) stack trace. The pilot trace is typically created from CMP binned seismic survey traces using binning techniques well known in the art. Combining time-domain transient electromagnetic signals recorded during a given seismic survey from a CMP increases the signal-to-noise ratio and creates “stacked” traces. Pilot trace construction is performed by using any of the processes understood by those of skill in the art.

Cross-correlation is a measure of the similarity of two waveforms, of the degree of linear relationship between them, and/or of the extent to which one is a linear function of the other. The theoretical maximum cross-correlation is equal to one, meaning the two compared waveforms are exactly the same in their shape, amplitude, and/or linear relationships. The “pick time” is the time difference or time shift of a stacked trace that corresponds to the maximum cross-correlations between the stacked trace and the pilot trace. Further decomposition of these times into surface-consistent values and CMP structure leads to the residual statics values.

For shear seismic data, SS and PS, however, these methods fail in the presence of anisotropy; the pick times are highly contaminated with non-surface-consistent delays as a function of azimuth and offset. Building the pilot using current binning techniques also proves difficult, since proper stacking using current techniques requires the anisotropy to be removed. Further, on PS data, the CMP structure term requires a transformation into the common-conversion point (CCP) domain. This conversion assumes the ratio of pressure wave velocity to shear wave velocity Vp/Vs is known. However, it is not; and, therefore, the ratio is usually assumed until proper statics are computed.

This conversion has made shear wave statics calculations difficult to compute and time-consuming. Additionally, both the CCP stack and CMP stack are often so poor in signal-to-noise quality before shear wave statics are applied that neither one can be used for picking reliable delay times. For example, a method for obtaining an initial estimate of large converted-wave statics is described in an article by Cary et al, A Simple Method For Resolving Large Converted-Wave (P-SV) Statics, Geophysics, Vol. 58, No. 3, pp 429-433, incorporated herein by reference and attached as a part of this disclosure as Appendix A. This method provides only an estimate of receiver statics but cannot easily discriminate between statics and structure.

Accordingly, there is a need for a method and system for resolving shear seismic statics that is relatively insensitive to the velocity ratio, does not require CCP conversion, and can handle anisotropy effects.

### SUMMARY OF THE INVENTION

According to one example embodiment of the invention, a method for determining statics for shear wave seismic data is provided. The method comprises, binning the seismic data into a bin defined by CDP information, azimuth information and offset information wherein a set of binned traces are defined; generating a pilot trace from the set of binned traces; cross-correlating the pilot trace with the binned traces; determining shot statics dependent on the cross-correlation; and determining receiver statics dependent on the cross-correlation. In a more specific embodiment, the binned traces are partially stacked defining partial stacks, and the cross-correlating is performed with the pilot trace and the partial stacks as a function of azimuth and offset. In a further embodiment, the method also includes applying noise reduction techniques to the pilot trace. In another embodiment, the method also includes applying the receiver statics and the shot statics to the binned traces, wherein corrected data is defined. In yet a further embodiment, the method also includes applying the receiver statics and the shot statics to the binned traces, wherein corrected data is defined, and recalculating the receiver and the shot statics using the corrected data in the generating and in the cross-correlating steps. In still further embodiments the method includes performing velocity analysis to the corrected data, performing NMO-correction to the corrected data, wherein NMO-corrected data is defined, and stacking the NMO-corrected data. In a more particular embodiment of the invention, the method comprises determining RNM corrections, applying the RNM corrections to the pilot trace, and determining the receiver and shot statics using the RNM corrected pilot trace.

According to a further example embodiment of the invention, a system for resolving shear wave seismic data is provided. The system comprises a computer, programmed to perform the steps of binning the seismic data into a bin defined by CDP information, azimuth information and offset information wherein a set of binned traces are defined; generating a pilot trace from the set of binned traces; cross-correlating the pilot trace with the binned traces; determining shot statics dependent upon the cross-correlation; and determining receiver statics dependent upon the cross-correlation. In a more specific embodiment, the binned traces are partially stacked defining partial stacks, and the cross-correlating is performed with the pilot trace and the partial stacks as a function of azimuth and offset.

### BRIEF DESCRIPTION OF THE DRAWINGS

FIG. 1 is a plan view of a typical offshore seismic survey configuration

FIG. 2a is a plan view of seismic waves in a typical offshore configuration

FIG. 2b is a plan view of seismic waves in a typical on-shore configuration

FIG. 3 is a functional block diagram illustrating one possible system incorporating the teachings of the present invention

FIG. 3a is a top view of a portion of a representative seismic survey, illustrating one possible binning technique incorporating the teachings of the present invention.

FIG. 3b is a cut-out view from FIG. 3a showing example offset ranges selected in accordance with the teachings of the present invention.

FIG. 3c is a functional block diagram illustrating one possible system for performing partial stacking.

FIG. 4 is a plot of a representative data stack before partial stacking correction

FIG. 5 is a plot of a representative data stack after partial stacking correction

FIG. 6 shows the FIG. 5 stack after RNM correction

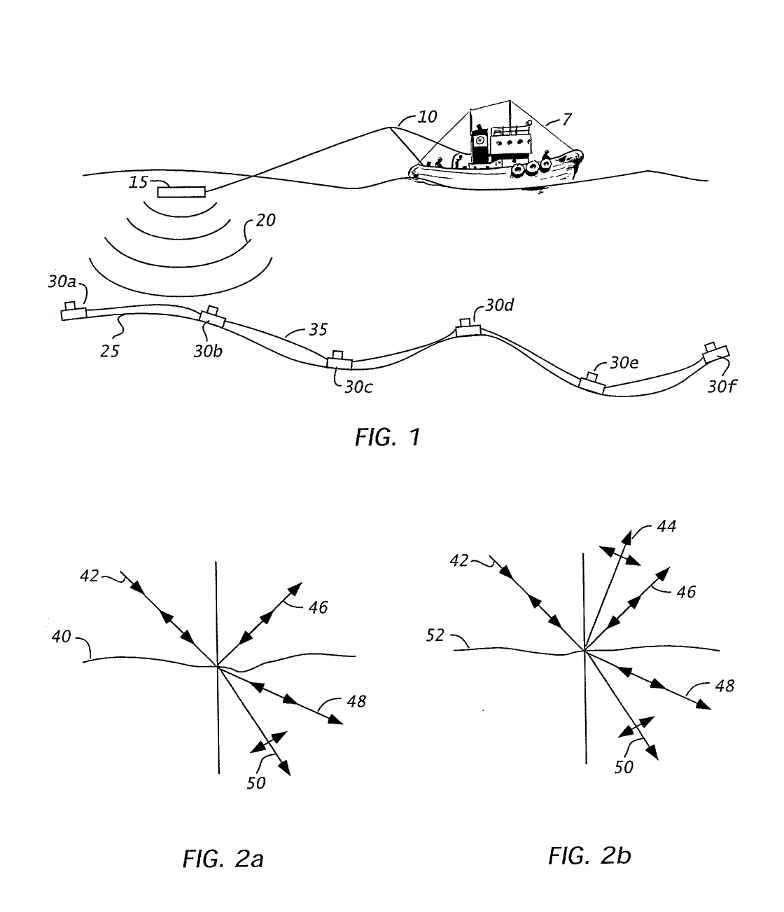

### DETAILED DESCRIPTION OF EXAMPLE EMBODIMENTS OF THE INVENTION

Shear wave seismic data is typically gathered using two geophones positioned horizontally on an X and Y-axis. In theory, the geophones can only detect waves having particle motion along the axis of movement of the mass of the geophone spring. Vertically traveling shear or S waves, whose particle motion is perpendicular to the direction of travel, are detected by horizontally positioned geophones. It is, however, not important how the data is collected as long as a method is used that records the resultant shear waves so data processing can be performed.

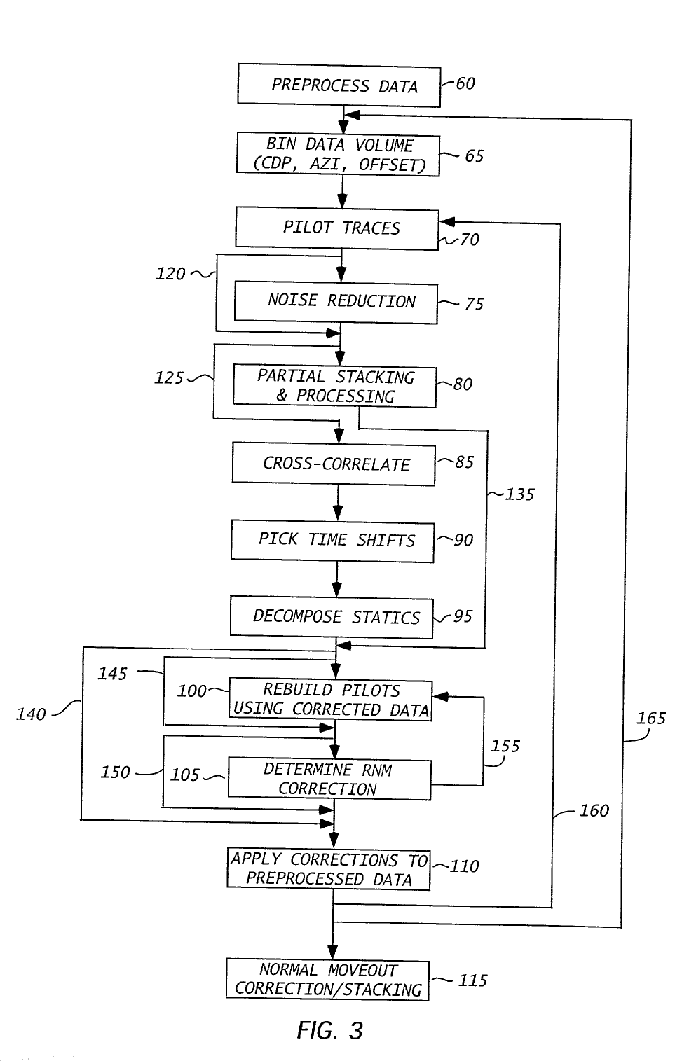

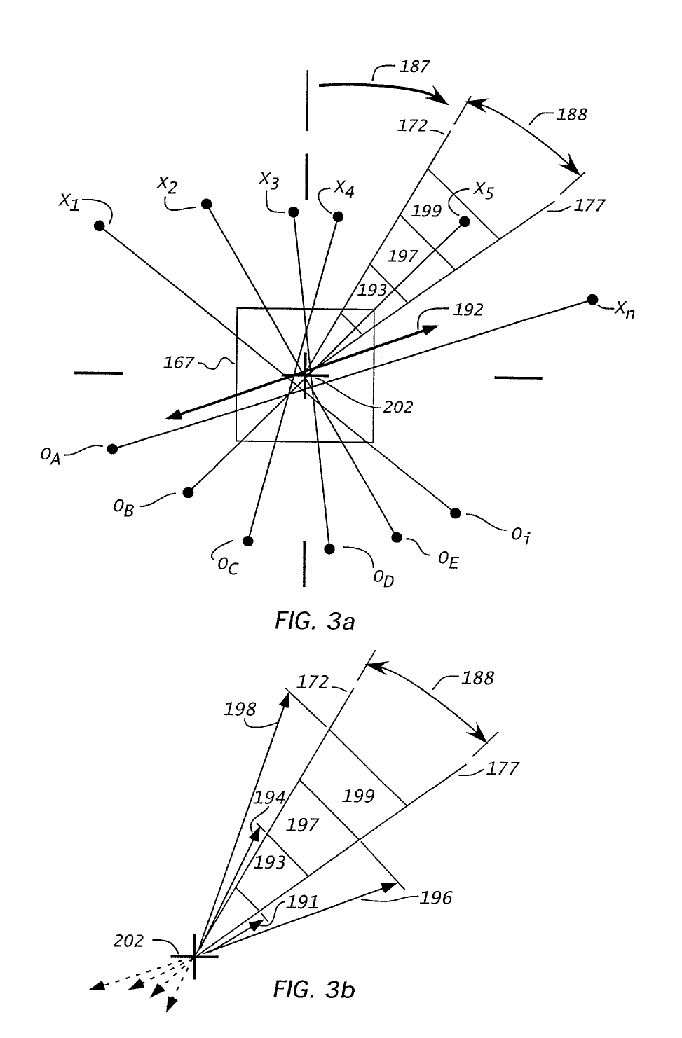

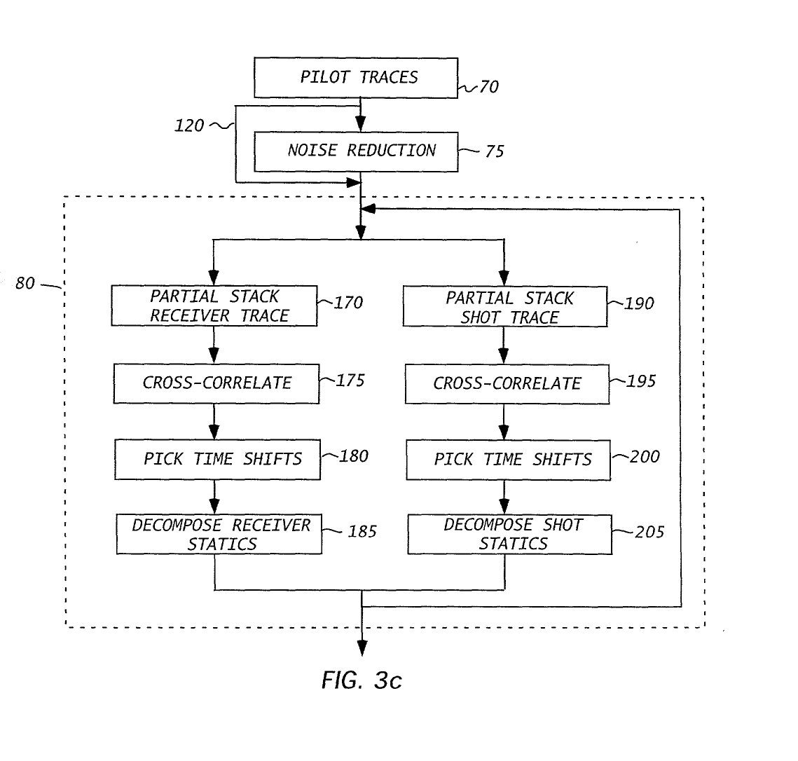

Referring now to FIG. 3, a functional block diagram is shown illustrating examples embodiments of the present invention. In one embodiment of the invention, a computer is programmed, using programming techniques well known in the art, in such a manner as to perform the functional steps in FIG. 3. In some embodiments, the computer is programmed using a single computer algorithm. In alternative embodiments of the invention, the computer is programmed using a series of computer subroutines combined into one functioning computer algorithm. In yet other embodiment of the invention, the system computer is programmed using a series of computer algorithms, in combination, to perform the steps in FIG. 3. It is noted that it is not necessary for the computer algorithms in the above embodiments to be written to complete all the functional steps in FIG. 3 during the same computer run-time session. In some embodiments, the algorithm or algorithms are written such that any number of steps are performed during a given computer run-time session.

Data is “preprocessed” 60 using, for example, deconvolution, normal moveout, amplitude recovery, and/or other methods/techniques commonly performed by those of skill in the art, before calculating the residual statics corrections. The data comprises mode-converted PS data, pure shear SS data, or any combination of PS and SS data. It is noted that preprocessing step 60 may be performed outside the present invention, such as by a third party or by the use of another computer program.

Referring now to FIG. 3a, a representative segment of a seismic survey is seen where shots are designated with “X₁-Xₙ,” receivers are designated with “O_{A}-Oᵢ,” and representative shot lines are shown between the shots and receivers. It will be understood that not all shots, receivers, and shot lines are shown for simplicity. The preprocessed data (as used herein “preprocessed data” includes data which has been subjected to at least one process traditionally performed on seismic data before traditional residual statics methods) from the shots and receivers is “binned” (FIG. 3 at 65), into three domains: common-depth point (CDP) 167, azimuth 187, and offset 192. In the illustrated example of FIG. 3a, CDP range 167 has its center point at cross-hair 202. Projecting from cross-hair 202 are radial lines 172 and 177 which encompass the traces (not shown) falling within a given azimuth range 188. Offset 192 is the distance from a shot X to a receiver O, as shown in FIG. 3a. Turning now to the FIG. 3a cut-out view FIG. 3b, in one example embodiment, bins 193, 197, and 199 are formed by selecting the traces (not shown) within CDP 167 (shown in FIG. 3a); azimuth range 188 (shown in FIG. 3a and 3b); and offset ranges 191 to 194, 194 to 196, and 196 to 198 (shown in FIG. 3b) respectively. In the illustrated example of FIG. 3a and FIG. 3b, the trapezoidal shapes between radial lines 172 and 177 define bins 193, 197, and 199. It will be understood that not all bins are seen in FIG. 3a or FIG. 3b for simplicity.

The dimensions of the various bins, 193, 197, and 199, seen in FIG. 3a and those not shown, are selected according to the variations on structure (CDP) and anisotropy (Azi, Off). In one embodiment of the invention, the bin dimensions are selected such that a hyperbolic assumption is valid for the traces within the bin. In another embodiment, the bin dimensions are selected such that traces are essentially flat within the bin. In an alternative embodiment, the traces are sorted or binned into azimuth ranges (e.g. 10° in increments from 0° to ≦360°, or any appropriate increment). Data is not available to know all the possible appropriate increments but others could be appropriate.

Pilot traces 70, FIG. 3, are constructed, in one embodiment of the invention, for each bin, 193, 197, 199, and those not shown in FIG. 3a, from the binned data and are used to determine time corrections (also known as time “shifts”). In an alternative embodiment, pilot traces are constructed for a plurality of the binned data-sets, from the binned data or “binned traces”, and are used to determine time corrections. In another embodiment, a single pilot trace is constructed for a single binned data-set, such as bin 193. Typically, in various embodiment of the invention, bins are formulated for all azimuth ranges and over all chosen offset ranges. The number of pilot traces constructed depends on the particular data being analyzed and the desired results sought, as it may not be necessary to construct pilot traces and calculate statics for all binned data-sets.

Pilot trace construction is performed by using any of the processes understood by those of skill in the art. For example, according to one embodiment of the present invention, each pilot trace is constructed starting with the binned traces in a given bin that are normal-moveout-corrected (“NMO-corrected) using a preliminary velocity function(s) (as is well known with pilot trace schemes for surface consistent residual statics). The nonzero-offset travel-time is mapped onto the zero-offset travel-time, removing the offset effect from the travel times (offset being the horizontal distance from a source point to the center of a receiver). The trace amplitudes from the NMO-corrected data are scaled to a common root-mean-square (rms) amplitude. The NMO-corrected data is then binned and stacked, forming a pilot trace corresponding to the given binned traces. The pilot trace is used for cross-correlation with the binned traces within the given bin.

Returning to FIG. 3, in another embodiment of the invention, noise reduction techniques, well known in the art, are applied at 75, although noise reduction is not a required step, as is shown by path 120.

For some embodiments the signal-to-noise ratio of the individual traces is poor and cross-correlations are noisy (even if the pilot is not noisy). So when the signal-to-noise ratios for the individual traces within a bin are not sufficient for successful cross-correlations, partial stacking and processing 80 is used to improve the signal-to-noise ratio. The cross-correlation using partial stacking is more accurate, which makes the picking of reliable delay times used for statics correction of the traces easier. In some such examples, the partial stacking comprises stacking multiple traces within a given bin before cross-correlation. A single receiver is selected and multiple traces from multiple shots to the same receiver within the same azimuth and offset range are stacked. The number of shot traces selected for partial stacking depends on the signal-to-noise ratio of the raw data. For example, if two traces are stacked and the signal-to-noise is sufficient for cross-correlation then only two traces are selected for partial stacking. If more traces are needed, then more are used, at least until the cross-correlations produce meaningful data that would be acceptable to one of skill in the art.

As is illustrated in one embodiment of the invention by the partial stacking process 80 in FIG. 3c, the partially stacked receiver trace 170 is cross-correlated 175 with the pilot trace corresponding to the bin from which the partially stacked receiver trace 170 was generated. In an alternative embodiment, partially stacked receiver trace 170 is cross-correlated 175 with the pilot trace corresponding to the bin from which the partially stacked receiver trace 170 was generated, after noise reduction 75. Time-shifts corresponding to the maximum cross-correlations between the partial stack receiver trace and the pilot trace are picked, FIG. 3c at 180. The picked times are decomposed 185 (various methods of such decomposition are known to those of ordinary skill in the art) to determine the receiver and shot statics. In one embodiment of the invention, since a common receiver and multiple shot locations were used in the partial stacking process, the shot statics derived from decomposition 185 are discarded, leaving only receiver statics 185. This partial stacking process is repeated for the same receiver using different shots, offsets, and azimuth ranges, until substantially all shots, azimuth ranges, and offsets are used, to determine the receiver statics for the receiver. In a similar process, illustrated by steps 190 through 205, partially stacking traces from receivers to a single shot, to determine the shot statics for a given shot is performed until all shot statics are determined for the given shot. In one embodiment of the invention, the process 80 is repeated for each receiver and shot in the bin until all the statics for all the receivers and all the shots within a given bin have been determined. There is no required or preferred order for determining receiver statics and shot statics using partial stacking.

Returning to FIG. 3, in another embodiment of the invention, when signal-to-noise ratios are sufficiently strong within a given bin, cross-correlation is performed at 85. The times shifts are picked 90 and the shot and receiver statics are decomposed 95. The process, as defined by steps 80 or 85 through 95, is repeated for each bin within the data set. Once the shot and receiver statics are calculated or “determined,” in one embodiment of the invention, the velocity corrections, are applied 140 to the preprocessed data 110. Any additional decomposition (derived to determine structural and residual moveout terms) is then performed, in various embodiments, as is well known in the art. The derived source and receiver terms are applied to the travel times on pre-NMO-corrected CDP gathers. Velocity analysis, NMO-correction and stacking 115, as are well-known in the art, are performed to complete the residual-statics corrections.

In another embodiment of the invention, using path 145, anisotropy effects are determined as residual normal moveout (RNM) corrections 105, using the pilot traces 70, and applied to the pilot traces within a region from which regional anisotropy effects are to be removed. Since velocity is a function of azimuth in anisotropic media, the total NMO is calculated by adding the NMO-derived from the preceding velocity analysis to the RNM function, thus removing the regional anisotropy. Here, horizons in the pilot traces 70 are picked and curve fitting is applied to the picked horizons, leading to a “RNM” function that comprises the fitted curve. In one embodiment of the invention, the horizons are picked in time gates that encompass strong horizons or events found in the pilot traces 70. In another embodiment of the invention, a shallow horizon is picked and a deeper horizon is picked. In still another embodiment of the invention, horizons are picked based on the continuity of the data at an anomaly as a function of time or azimuth or both time and azimuth. Picking is performed in either an automated fashion (such as through the use of a system computer programmed to perform picking) or in a manual fashion. Other methods for picking horizons will occur to those of skill in the art.

In many embodiments, curve fitting is performed according to various methods, some of which will occur to those skilled in the art, to determine the anisotropy effects RNM function. In one unique embodiment of the invention, a curve fitting function is described by equation (1):

RNM=k*OFFSET*cos(2*AZIMUTH+Slazimuth) (1)

where k=constant and S1 =the fast direction azimuth. The constant k is a function of amplitude and will vary according to the curve being fitted. In another embodiment of the invention, the curve fitting results in a polynomial function. It is noted that any curve fitting system is acceptable. The RNM corrections are then applied 155 to the pilot traces 100 within the picked horizons described by the alternative embodiments above.

In many embodiments, statics are recalculated using the corrected pilot traces 100. The corrected pilot traces 100 are used at path 150 along with the corrected preprocessed data 110 for outer-looping. The phrase “outer looping” is used here to describe the paths 160 and 165 as shown in FIG. 3. Outer looping is performed, in one embodiment of the invention, by re-calculating all the shot and receiver statics at step 80, or at steps 85-95 in an alternative embodiment, as discussed above, using the corrected data 110, and updated pilot traces 100 at path 160. In still another embodiment of the invention, outer looping is performed using only the corrected data 110 at path 160, rebuilding the pilot traces 70, and recalculating the statics. It is also noted that the RNM correction, in one embodiment of the invention, is determined and applied to the pilot traces within the picked horizons, not shown, before the statics are computed for all the bins at step 80 or steps 85-95.

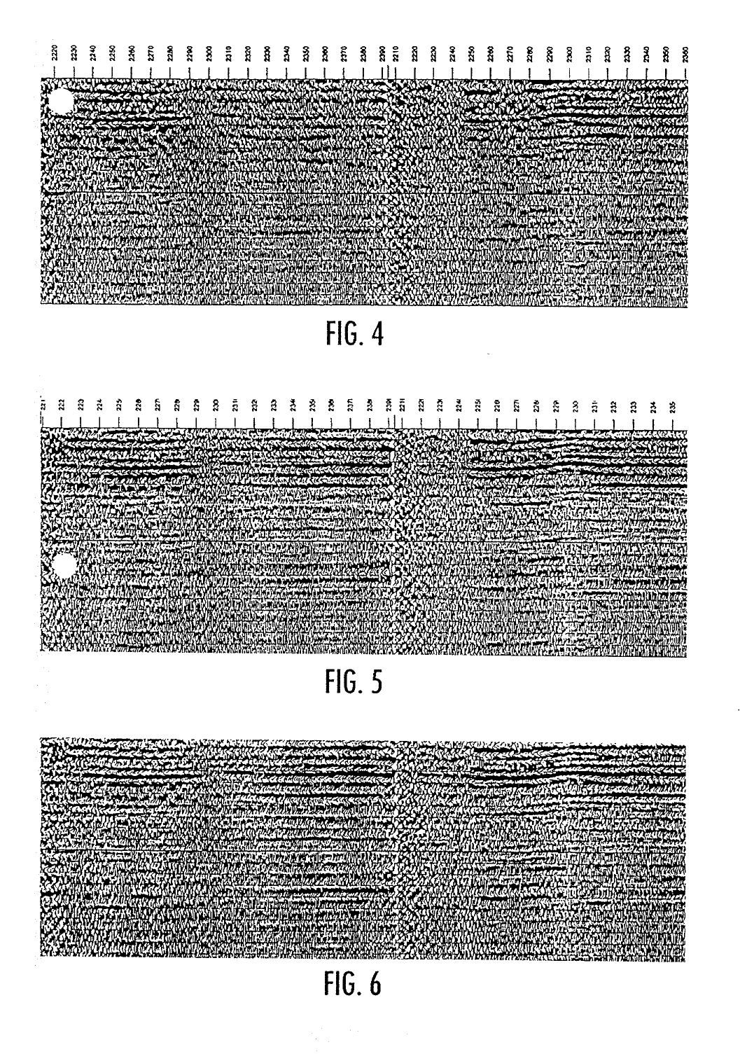

In many embodiments, the corrected pilot traces are used according to various logical paths shown in FIG. 3 to determine statics. In a further embodiment of the invention, the RNM correction is calculated by applying the derived residual statics, from 80 and 95 as appropriate, to the preprocessed data, not shown, and rebuilding the pilot traces 100. Horizon picking and curve fitting is performed, as described above, to determine the RNM function. In one alternative embodiment, the pilot traces within given picked horizons are RNM corrected 150, as described by the alternative RNM embodiment above, at 100 and used along with the preprocessed data 110 at path 160 to recalculate the statics. In another alternative embodiment, the corrected preprocessed traces 110 are used to rebuild the pilot traces 70 at path 160. The RNM correction is then applied to the new pilot traces 70 within given picked horizons and the statics are recalculated using the many alternative embodiments discussed above. FIG. 4 shows a representative stack before partial-stacking correction. FIG. 5 shows a representative stack after partial-stacking correction. FIG. 6 shows the same representative stack after RNM corrections have been added to the partial-stacking corrections shown in FIG. 5.

In many embodiment of the invention, path 165 is used, in lieu of path 160 for statics calculations. Since the corrected preprocessed data 110 may now be “flatter” than before the first statics were calculated and applied, in one embodiment of the invention, larger bins are selected at 65. The process for determining statics is again performed according to the alternative embodiments discussed above.

In one embodiment of the invention, the outer-looping process is performed multiple times using path 160 to achieve convergence on the derived statics. In another embodiment of the invention, the outer-looping process is performed multiple times using path 165 to achieve convergence. In yet a further embodiment of the invention, the outer-looping process is performed using paths 160 and 165 in any combination. In still a further embodiment, the outer looping process is performed multiple time using paths 160 and 165 multiple times.

The embodiments of the invention described herein are only for purposes of illustration and understanding of examples of the invention. Other embodiments of this invention will occur which do not depart from the spirit of the invention. Accordingly, the invention shall be limited in scope only by the attached claims.

What is claimed is:

1. A method for determining statics for shear wave seismic data, the method comprising:
binning said seismic data in a bin defined by CDP information, azimuth information, and offset information, wherein a set of binned traces is defined;
generating a pilot trace from the set of binned traces;
cross-correlating said pilot trace with said binned traces;
determining shot statics dependent on the cross-correlation; and
determining receiver statics dependent on the cross-correlation.

2. The method as defined by claim 1 wherein said binned traces are partially stacked wherein partial stacks are defined, and
wherein said cross-correlating is performed with said pilot trace and said partial stacks as a function of azimuth and offset.

3. The method as defined by claim 2 further comprising applying noise reduction techniques to the pilot trace.

4. The method as defined by claim 2 further comprising,
applying said receiver statics and said shot statics to said binned traces, wherein corrected data is defined, and
recalculating said receiver and said shot statics using said corrected data in said generating and in said cross-correlating steps.

5. The method as defined by claim 2 further comprising applying said receiver statics and said shot statics to said binned traces, wherein corrected data is defined.

6. The method as defined by claim 5 further comprising,
performing velocity analysis to said corrected data,
performing NMO-correction to said corrected data, wherein NMO-corrected data is defined, and
stacking said NMO-corrected data.

7. The method as defined by claim 6 further comprising
determining RNM corrections,
applying said RNM corrections to said pilot trace, and
determining said receiver and shot statics using the RNM-corrected pilot trace.

8. The method as defined by claim 1 further comprising applying noise reduction techniques to the pilot trace.

9. The method as defined by claim 1 further comprising,
applying said receiver statics and said shot statics to said binned traces, wherein corrected data is defined, and
recalculating said receiver and said shot statics using said corrected data in said generating and in said cross-correlating steps.

10. The method as defined by claim 1 further comprising applying said receiver statics and said shot statics to said binned traces, wherein corrected data is defined.

11. The method as defined by claim 10 further comprising,
performing velocity analysis to said corrected data,
performing NMO-correction to said corrected data, wherein NMO-corrected data is defined, and
stacking said NMO-corrected data.

12. The method as defined by claim 11 further comprising
determining RNM corrections,
applying said RNM corrections to said pilot trace, and
determining said receiver and shot statics using the RNM-corrected pilot trace.

13. A system for resolving shear wave seismic data comprising a computer, programmed to perform the steps of:
binning the seismic data in a bin defined by CDP information, azimuth information and offset information; wherein a set of binned traces are defined;
generating a pilot trace from said set of binned traces;
cross-correlating said pilot trace with said binned traces;
determining shot statics dependent upon said cross-correlation; and
determining receiver statics dependent upon said cross-correlation.

14. The computer system for resolving shear wave seismic data of claim 13 wherein said binned traces are partially stacked wherein partial stacks are defined, and
wherein said cross-correlating is with said pilot trace and said partial stacks as a function of azimuth and offset.
